(19) United States
(12) Patent Application Publication
(10) Pub. No.: US 2014/0317670 A1
(43) Pub. Date: Oct. 23, 2014

(54) METHOD AND APPARATUS FOR REPRODUCING CONTENTS IN MULTIMEDIA SYSTEM

(71) Applicant: Samsung Electronics Co., Ltd., Suwon-si (KR)

(72) Inventors: Ji-Eun KEUM, Suwon-si (KR); Young-Kwon LIM, Goyang-si (KR); Sung-Ryeul RHYU, Yongin-si (KR)

(73) Assignee: Samsung Electronics Co., Ltd., Suwon-si (KR)

(21) Appl. No.: 14/258,514

(22) Filed: Apr. 22, 2014

(30) Foreign Application Priority Data
Apr. 22, 2013 (KR) 10-2013-0044193

(51) Int. Cl. H04N 21/234

(52) U.S. Cl. CPC H04N 21/23424
USPC 725/116

(57) ABSTRACT

A method and an apparatus for reproducing content by a terminal in a multimedia system are provided. The method includes receiving segment information from a first content provider for providing a first content, and reproducing a second content at a specific time point in a reproduction period of the first content based on the received segment information. The segment information comprises information on a time point when reproduction of the first content is to be stopped and an identifier indicating a reproduction period of the second content which is to be reproduced after the reproduction of the first content is stopped.

### CROSS-REFERENCE TO RELATED APPLICATION(S)

This application claims the benefit under 35 U.S.C. §119(a) of a Korean patent application filed on Apr. 22, 2013 in the Korean Intellectual Property Office and assigned Serial number 10-2013-0044193, the entire disclosure of which is hereby incorporated by reference.

### TECHNICAL FIELD

The present disclosure relates to a method and an apparatus for reproducing content in a multimedia system.

### BACKGROUND

In recent years, emphasis is placed on smooth transmission of content. Accordingly, adaptive streaming technologies of adaptively changing bitrates of content according to an available transmission bandwidth or a change in performance of a user's device have been actively discussed. Since the adaptive streaming technologies can provide a service with a variable quality in consideration of a network environment, they can continuously provide content to the user.

The adaptive streaming technologies include a Dynamic Adaptive Streaming over HTTP (DASH) based on Hyper Text Transfer Protocol (HTTP). The DASH technology is a technology related to a method of configuring content and a method of transmitting content, and suggests a format for forwarding Moving Picture Experts Group (MPEG) media through HTTP at a variable speed.

However, when the DASH technology is used, it is impossible to switch from one content to another during use of the specific content. When the DASH technology is used, it cannot be guaranteed to switch from a specific content to another content and use the specific content again.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for reproducing content in a multimedia system.

Another aspect of the present disclosure is to provide a method and an apparatus for stopping reproduction of a specific content and reproducing another content.

Another aspect of the present disclosure is to provide a method and an apparatus for reproducing a specific content, reproduction of which has been stopped, again if another content is completely reproduced.

In accordance with an aspect of the present disclosure, a method of reproducing content by a terminal in a multimedia system is provided. The method includes receiving segment information from a first content provider for providing a first content, and reproducing a second content at a specific time point in a reproduction period of the first content based on the received segment information, wherein the segment information includes information on a time point when reproduction of the first content is to be stopped and an identifier indicating a reproduction period of the second content which is to be reproduced after the reproduction of the first content is stopped.

In accordance with another aspect of the present disclosure, a terminal in a multimedia system is provided. The terminal includes a wireless unit configured to receive segment information from a first content provider for providing a first content, and a content managing unit configured to reproduce a second content at a specific time point in a reproduction period of the first content based on the received segment information, wherein the segment information includes information on a time point when reproduction of the first content is to be stopped and an identifier indicating a reproduction period of the second content which is to be reproduced after the reproduction of the first content is stopped.

In accordance with another aspect of the present disclosure, a method of reproducing content of a content provider in a multimedia system is provided. The method includes transmitting segment information including a segment of a first content and information on a time point when reproduction of the first content is to be stopped, and an identifier indicating a reproduction period of a second content which is to be reproduced after the reproduction of the first content is stopped, and transmitting a segment of the second content to the terminal

In accordance with another aspect of the present disclosure, a content provider in a multimedia system is provided. The content provider includes a control unit configured to generate segment information including information on a time point when reproduction of the first content is to be stopped and an identifier indicating a reproduction period of the second content which is to be reproduced after the reproduction of the first content is stopped, and a wireless unit configured to transmit a segment of the first content, the segment information, and a segment of the second content.

Embodiments of the present disclosure can switch a specific content to another content while the specific content is used in a multimedia system in which a DASH technology is used. Further, embodiments of the present disclosure can use a specific content again after switching the specific content to another content.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows a time point when advertising content is inserted into main content according to an embodiment of the present disclosure;

FIG. 2 is a signal flow diagram showing a method of reproducing content in a multimedia system according to an embodiment of the present disclosure;

FIG. 3 is a block diagram of a terminal according to an embodiment of the present disclosure;

FIG. 4 is a block diagram of a content provider according to an embodiment of the present disclosure;

FIG. 5 is a flowchart showing an operation of the terminal according to the embodiment of the present disclosure; and

FIG. 6 is a flowchart showing an operation of the content provider according to the embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure provides a method and an apparatus for reproducing content in a multimedia system. The present disclosure suggests a method and an apparatus which can switch a specific content to another content during reproduction of the specific content, and if the reproduction of the other content is completed, can reproduce the specific content again. According to an embodiment of the present disclosure, the specific content will be referred to as main content and the other content will be referred to as advertising content. However, it is apparent that the other content may be changed to various content without being limited to advertising content.

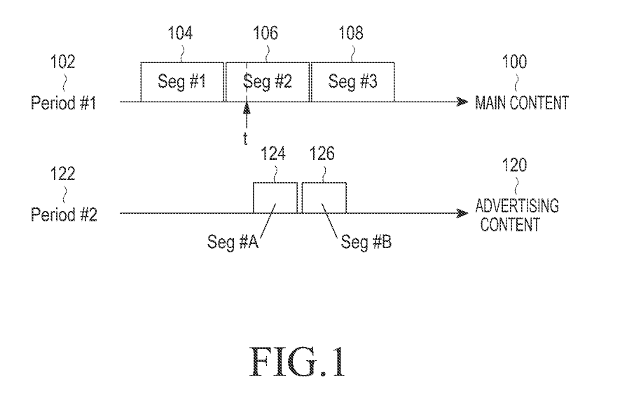

In order to reproduce the advertising content while the main content is reproduced, segments of the advertising content should be inserted at a time point in a time period in which segments of the main content are transmitted. This will be described in detail with reference to FIG. 1.

FIG. 1 shows a time point when advertising content is inserted into main content according to an embodiment of the present disclosure.

Referring to FIG. 1, the main content 100 includes three segments 104, 106, and 108, and may be reproduced for a first period 102. The advertising content 120 includes two segments 124 and 126, and may be reproduced for a second period 122. Although FIG. 1 shows that the second period 122 is smaller than the first period 102, the second period 122 may be equal to or larger than the first period 102.

The time point when the reproduction of the advertising content 120 is started may be a specific time point in a period in which the three segments 104, 106, and 108 are reproduced, that is, the second period 102. FIG. 1 shows an example in which the reproduction of the advertising content 120 is started at a time point t in a period in which the second segment 106 is reproduced. A reproduction starting time point of the advertising content 102 may be expressed in Equation 1.

At time=t within Segment #N Equation 1

In Equation 1, At time indicates a reproduction starting time point (i.e., a time point when the reproduction of the main content 100 is stopped and the reproduction of the advertising content 120 is started and t within Segment #N indicates a specific time point in a period in which a N-th segment (N=2 in the embodiment of FIG. 1) of the main content 100 is reproduced.

When the advertising content 120 is reproduced at a time point t in the period in which the main content 100 is reproduced, the content reproduction order in a client (for example, a terminal) may appear as follows.

Content reproduction order: a first segment 104 of the main content 100 ->a first part of a second segment 106 of the main content 100 (before a time point t) ->a first segment 124 and a second segment 126 of the advertising content 120 ->a second (remaining) part of a second segment 106 of the main content 100 ->a third segment 108 of the main content 100.

The content reproduction time according to the content reproduction order may be a time obtained by adding the first period 102 and the second period 122 as both the main content 100 and the advertising content 120 are reproduced.

The following information may be provided to the client such that the advertising content 120 is reproduced.

TABLE 1

| Element or | | |
|---|---|---|
| Attribute Name | Use | Description |
| Break in through | 0 . . . N | Stop play the segment and play the |
| | | referred period at @referenced |
| | | period ID |
| @t | 1 | Specifies the time when the client |
| | | pause to play the segment |
| @referenced | 1 | Specifies the period ID to be |
| period ID | | played continually |

In Table 1, “Break in through” indicates that the reproduction of the corresponding segment is to be stopped and a period according to “@referenced period ID” is to be reproduced (i.e., the reproduction of a segment of the main content 100 is to be stopped and a segment of the advertising content 120 is to be reproduced for the second period 122), “@t” indicates a time when the client stops the reproduction of a segment (i.e., a time when a segment of the main content 100 is to be stopped), and “@referenced period ID” indicates an identifier of a period which is to be reproduced continuously (for example, an identifier of the second period 122).

The characteristics of periods for various content may be expressed as in Table 2, and may be additionally included in period information of the content and may be transmitted.

TABLE 2

| Element or | | |
|---|---|---|
| Attribute Name | Use | Description |
| Period | | Specifies the information of a Period |
| @type | O | Specifies the processing instructions, |
| | | which can be either “main” or “inserted”. |
| | | If not present, default value is “main”. |
| | | If the value is “inserted”, then the client |
| | | shall play this period only when |
| | | indicated by <Break in through> |

In Table 2, “Period” indicates period information of the corresponding content and “@type” indicates a processing indicator indicating “main” or “inserted” as low level information of “Period” (for example, indicating a period for the main content 100 or a period for the advertising content 120). When a value of “@type” is not present, a value of “@type” may be set to “main” as a default, and when a value of “@type” is “inserted”, it may indicate that the client should reproduce the corresponding content only for a corresponding period according to the value of “Break in through”.

Although not indicated in Table 2, content may be continuously switched by adding a new value of “prefetched” to “@type” and allowing a client to buffer a segment of the corresponding content in advance before reproducing the content.

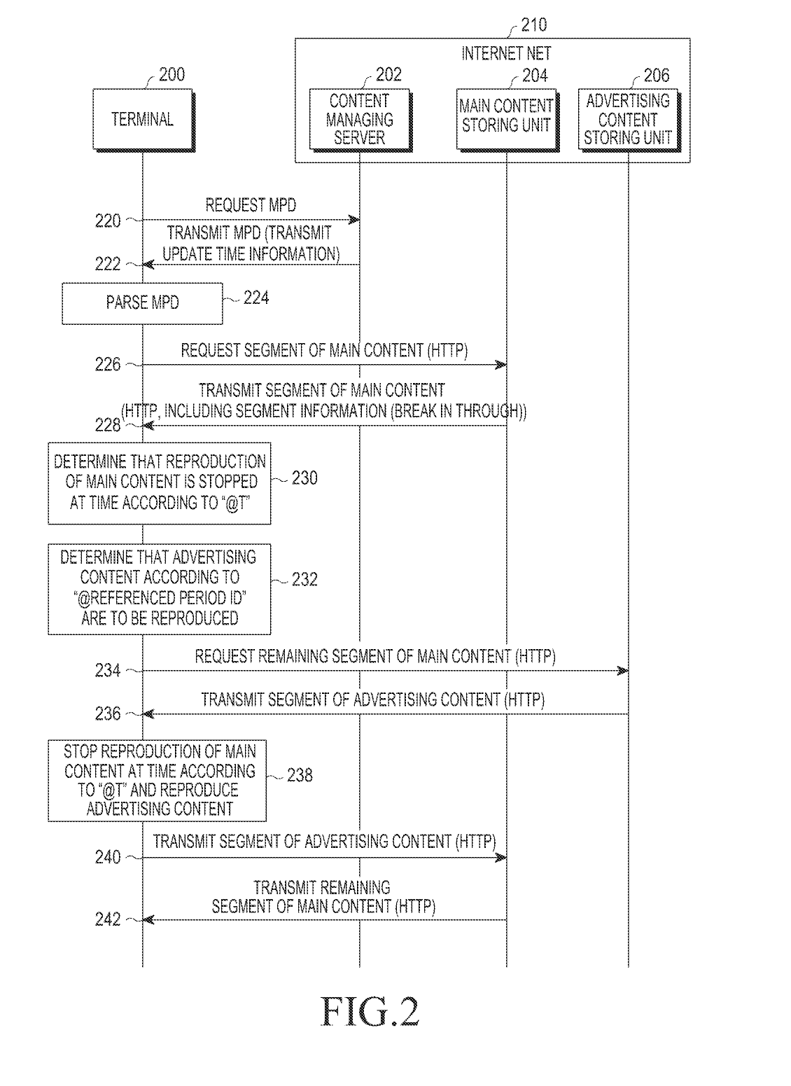

A method of reproducing content according to an embodiment of the present disclosure is described below with reference to FIG. 2.

FIG. 2 shows a signal flow of a method of reproducing content in a multimedia system according to an embodiment of the present disclosure.

Referring to FIG. 2, the terminal 200 receives content through a content managing server 202, a main content storing unit 204, and an advertising content storing unit 206 in an Internet network 210.

The terminal 200 transmits a request for Media Presentation Description (MPD) to the content managing server 202 in operation 220. The content managing server 202 transmits the MPD to the terminal 200 in operation 222. When receiving the MPD, the terminal 200 parses the MPD and acquires information on a content segment (initial segment information, URL information, and the like) in operation 224.

The terminal 200 requests a segment for the main content 100 from the main content storing unit 204 in operation 226. The main content storing unit 204 transmits the segment of the main content 100 to the terminal 200 in operation 228. The main content storing unit 204 may transmit the segment information listed in Tables 1 and 2, which has been described above, to the terminal 200.

The information of the period to which the segment pertains may include “Period @type” set to “main”, and the terminal 200 may determine that the reproduction of the main content 100 is to be stopped and the content according to “@referenced period ID” is to be reproduced based on “Break in through” included in the segment information. The terminal 200 may determine that the reproduction of the main content 100 is to be stopped at a time according to “@t” in operation 230. The terminal 200 determines that the content according to “@referenced period ID”, for example, the advertising content 120, is to be reproduced in operation 232, and requests a segment of the advertising content 120 from the advertising content storing unit 206 in operation 234. The advertising content storing unit 206 transmits the segment of the advertising content 120 to the terminal 200 in operation 236. Period information of the advertising content 120 in which “Period @type” is set to “inserted” also may be transmitted to the terminal 200.

If a time according to “@t” elapses, the terminal 200 stops the reproduction of the main content 100 and starts reproduction of the advertising content 120 in operation 238. Subsequently, if the reproduction of the advertising content 120 is completed, the terminal 200 requests a segment of the main content 100, which is to be reproduced, from the main content storing unit 204. The main content storing unit 204 transmits the remaining segment of the main content 100 to the terminal 200 in operation 242.

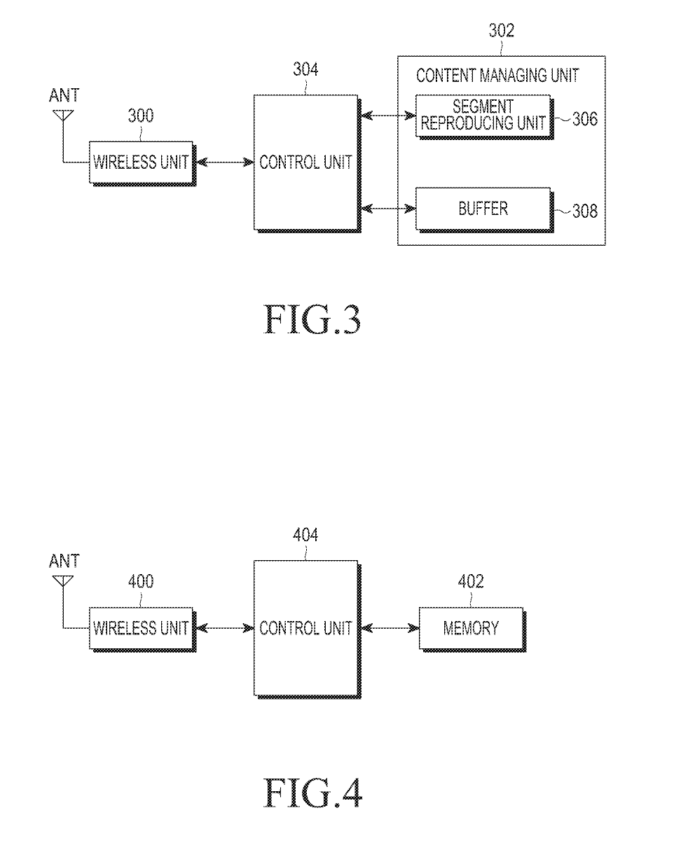

Internal configurations and operations of the terminal 200 and the content provider are described below with reference to FIGS. 3 to 6. The content provider may be a device, such as the main content storing unit 204 or the advertising content storing unit 206 shown in FIG. 2, which may provide content to the terminal 200.

FIG. 3 shows a configuration of a terminal according to an embodiment of the present disclosure.

Referring to FIG. 3, the terminal 200 includes a wireless unit 300, a content managing unit 302, and a control unit 304.

The wireless unit 300 performs communications through an Internet network. For example, the wireless unit 300 may transmit a request for MPD to the content managing server 202, and receives the MPD from the content managing server 202. The wireless unit 300 requests a segment of the main content 100 from the main content storing unit 204, and receives a segment and segment information of the main content 100 from the main content storing unit 204. The wireless unit 300 requests a segment of the advertising content 120 from the advertising content storing unit 206, and receives a segment of the advertising content 120 from the advertising content storing unit 206.

The content managing unit 302 includes a segment reproducing unit 306 for reproducing a content segment received through the wireless unit 120 and a buffer 308 for storing the received content segment. A plurality of buffers 308 may be provided to store segments for content.

The content managing unit 302 identifies a reproduction time of the received content segment, and controls the segment reproducing unit 306 such that the corresponding segment may be reproduced according to the identified segment reproduction time. The content managing unit 302 stores segments for content in different buffers and controls such that the segments for content may be buffered, respectively.

The control unit 304 controls the wireless unit 120 and the content managing unit 302 to perform an operation of the terminal 200 according to an embodiment of the present disclosure.

FIG. 4 shows a configuration of a content provider according to an embodiment of the present disclosure.

Referring to FIG. 4, the content provider may be a device, such as the main content storing unit 204 or the advertising content storing unit 206 shown in FIG. 2, which may provide content to the terminal 200. The content provider includes a wireless unit 400, a memory 402, and a control unit 404.

The wireless unit 400 communicates with the terminal, and when receiving a request for a content segment from the terminal 200, the wireless unit 400 may transmit a segment of the corresponding content to the terminal 200. The wireless unit 400 may transmit segment information listed in Tables 1 and 2 to the terminal 200.

The memory 402 stores specific content, and the control unit 404 controls the wireless unit 400 and the memory 404 to perform an operation of the content provider (the main content storing unit 204 or the advertising content storing unit 206) according to an embodiment of the present disclosure. In particular, the control unit 404 generates segment information listed in Tables 1 and 2.

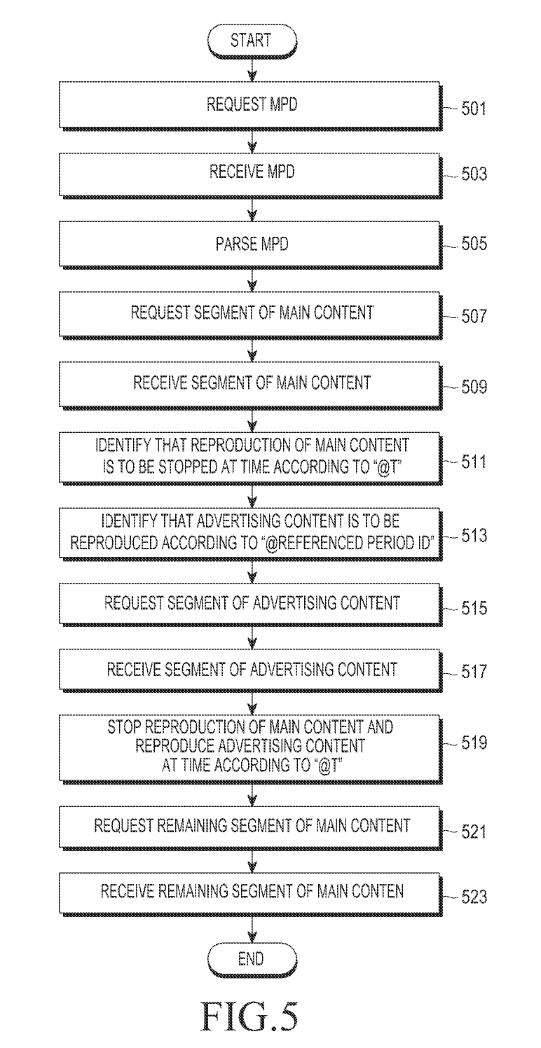

FIG. 5 shows an operation of a terminal according to an embodiment of the present disclosure.

Referring to FIG. 5, the terminal 200 transmits a request for MPD to the content managing server 202 at operation 501, and receives the MPD from the content managing server 202 at operation 503. The terminal 200 parses the received MPD and acquires information on a content segment (initial segment information, URL information, and the like) at operation 505.

The terminal 200 requests a segment on the main content 100 from the content provider at operation 507, and receives the segment of the main content 100 from the content provider at operation 509. The terminal 200 receives segment information listed in Tables 1 and 2, which has been described above.

The terminal 200 identifies that the reproduction of the main content 100 is to be stopped at a time according to “@t” from the received segment at operation 511, and identifies that the advertising content 120 according to “@referenced period ID” is to be reproduced at operation 513.

The terminal 200 requests a segment of the advertising content from the content provider to reproduce the advertising content 120 according to “referenced period ID” at operation 515, and receives the segment of the advertising content from the content provider at operation 517.

If a time according to “@t” elapses, the terminal 200 stops the reproduction of the main content 100 and reproduces the advertising content 120 at operation 519. If the reproduction of the advertising content 120 is completed, the terminal 200 requests the remaining segment of the main content from the content provider at operation 521, and receives the remaining segment of the main content from the content provider at operation 523 in order to continuously reproduce the stopped main content at operation 523.

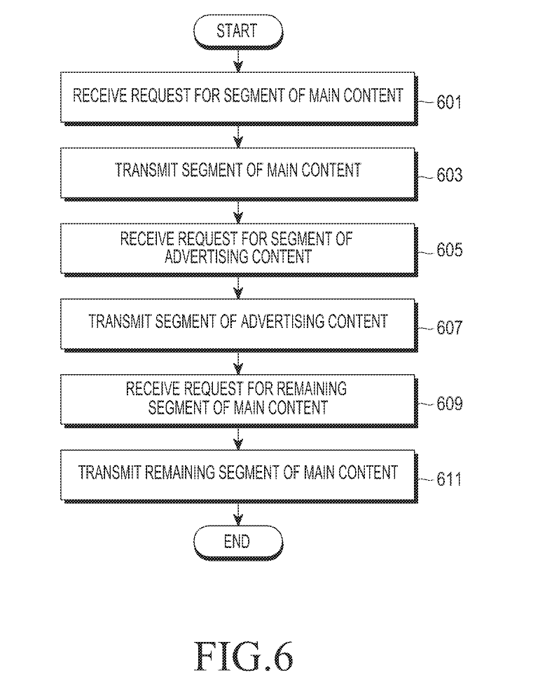

FIG. 6 shows an operation of a content provider according to the embodiment of the present disclosure.

Referring to FIG. 6, the content provider receives a request for a segment on the main content from the terminal 200 at operation 601. The content provider transmits the segment of the main content and the segment information listed in Tables 1 and 2, which has been described above, to the terminal 200 at operation 603.

When receiving a request for a segment for advertising content from the terminal 200 at operation 605, the content provider transmits the segment of the advertising content to the terminal 200 at operation 607. When receiving a request for the remaining segment of the main content for continuously reproducing the stopped main content from the terminal 200 at operation 609, the content provider transmits the remaining segment of the main content to the terminal 200 at operation 611.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of reproducing content by a terminal in a multimedia system, the method comprising:
receiving segment information from a first content provider for providing a first content; and
reproducing a second content at a specific time point in a reproduction period of the first content based on the received segment information,
wherein the segment information comprises information on a time point when reproduction of the first content is to be stopped and an identifier indicating a reproduction period of the second content which is to be reproduced after the reproduction of the first content is stopped.

2. The method of claim 1, wherein the segment information further comprises information indicating that the reproduction of the first content is stopped and the second content is to be reproduced and information on the reproduction period of the first content.

3. The method of claim 2, wherein the information of the reproduction period of the first content further comprises at least one of information indicating that the first content is content into which another content can be inserted to be reproduced and information indicating that the second content is to be buffered before the specific time point.

4. The method of claim 1, wherein the reproducing of the second content comprises:
stopping the reproduction of the first content at a time point when the reproduction of the first content is to be stopped;
requesting a second content provider for providing the second content to provide the second content, and receiving the second content from the second content provider; and
reproducing the second content for a period of time according to a reproduction period of the second content.

5. The method of claim 1, further comprising, if the reproduction of the second content is completed, reproducing the first content again.

6. A terminal in a multimedia system, the terminal comprising:
a wireless unit configured to receive segment information from a first content provider for providing a first content; and
a content managing unit configured to reproduce a second content at a specific time point in a reproduction period of the first content based on the received segment information,
wherein the segment information comprises information on a time point when reproduction of the first content is to be stopped and an identifier indicating a reproduction period of the second content which is to be reproduced after the reproduction of the first content is stopped.

7. The terminal of claim 6, wherein the segment information further comprises information indicating that the reproduction of the first content is stopped and the second content is to be reproduced and information on the reproduction period of the first content.

8. The terminal of claim 7, wherein the information of the reproduction period of the first content further comprises at least one of information indicating that the first content is content into which another content can be inserted to be reproduced and information indicating that the second content is to be buffered before the specific time point.

9. The terminal of claim 6, wherein the content managing unit stops the reproduction of the first content at a time point when the reproduction of the first content is to be stopped, and if the wireless unit receives the second content from the second content provider as the wireless unit requests a second content provider for providing the second content to provide the second content, the second content is reproduced for a period of time according to a reproduction period of the second content.

10. The terminal of claim 6, wherein, if the reproduction of the second content is completed, the content managing unit reproduces the first content again.

11. A method of reproducing content of a content provider in a multimedia system, the method comprising:
transmitting segment information comprising a segment of a first content and information on a time point when reproduction of the first content is to be stopped, and an identifier indicating a reproduction period of a second content which is to be reproduced after the reproduction of the first content is stopped; and
transmitting a segment of the second content to the terminal.

12. The method of claim 11, wherein the segment information further comprises information indicating that the reproduction of the first content is stopped and the second content is to be reproduced and information on the reproduction period of the first content.

13. The method of claim 12, wherein the information of the reproduction period of the first content further comprises at least one of information indicating that the first content is content into which another content can be inserted to be reproduced and information indicating that the second content is to be buffered before the specific time point.

14. A content provider in a multimedia system, the content provider comprising:
a control unit configured to generate segment information comprising information on a time point when reproduction of the first content is to be stopped and an identifier indicating a reproduction period of the second content which is to be reproduced after the reproduction of the first content is stopped; and
a wireless unit configured to transmit a segment of the first content, the segment information, and a segment of the second content.

15. The content provider of claim 14, wherein the segment information further comprises information indicating that the reproduction of the first content is stopped and the second content is to be reproduced and information on the reproduction period of the first content.

16. The content provider of claim 15, wherein the information of the reproduction period of the first content further comprises at least one of information indicating that the first content is a content into which another content can be inserted to be reproduced and information indicating that the second content is to be buffered before the specific time point.

17. A non-transitory computer-readable storage medium storing instructions that, when executed, cause at least one processor to perform the method of claim 1.

18. A non-transitory computer-readable storage medium storing instructions that, when executed, cause at least one processor to perform the method of claim 11.
